(19) United States
(12) Patent Application Publication
(10) Pub. No.: US 2007/0176853 A1
(43) Pub. Date: Aug. 2, 2007

(54) Control panel device and display

(76) Inventor: Hideo Miyano, Shizuoka (JP)

Correspondence Address: FROMMER LAWRENCE & HAUG LLP, 745 FIFTH AVENUE, NEW YORK, NY, 10151, US

(21) Appl. No.: 11/698,430

(22) Filed: Jan. 26, 2007

(30) Foreign Application Priority Data
Jan. 30, 2006 (JP) P2006-020590

(51) Int. Cl. G09G 3/04

(52) U.S. Cl. 345/34

(57) ABSTRACT

Disclosed herein is a control panel device includes: a substrate; a panel section disposed oppositely to one principal surface of the substrate, with a predetermined spacing therebetween; an operating member exposed at a panel surface, on the opposite side of the substrate, of the panel section; a detecting element provided on the substrate and operative to detect an operation on the operating member; a display configured to display information on the panel surface; and a control unit configured to control operations of the display based on a signal obtained according to detection by the detecting element; wherein the display includes a light emitting element; a shaping member; a rod lens array; and a rear screen.

### CROSS REFERENCES TO RELATED APPLICATIONS

The present invention contains subject matter related to Japanese Patent Application JP 2006-020590 filed in the Japanese Patent Office on Jan. 30, 2006, the entire contents of which being incorporated herein by reference.

### BACKGROUND OF THE INVENTION

1. Field of the Invention

The present invention relates to a control panel device and a display.

2. Description of the Related Art

In a control panel, generally, a display capable of displaying numerical values and characters, such as a liquid crystal display and a segment display, is provide for permitting the user to visually check the operating conditions of a controlled system, etc. FIG. 1A is a perspective view for partly perspectively showing a control panel device 101 according to the related art, and FIG. 1B is a side view for partly perspectively showing the control panel device 101. The control panel device 101 is for controlling the operations of a controlled system by depressing a keytop 102, and information according to the depressing operation is displayed on a display 103 configured by use of a segment display 103. A main substrate 106 provided with a switch 105 operated by depressing the keytop 102 is provided in the inside of a casing 104 of the control panel device 101.

Since various electronic parts such as the switch 105 are mounted on the main substrate 106, the main substrate 106 and a panel surface S101 of the casing 104 should be spaced from each other. Therefore, if the display 103 is disposed directly on the main substrate 106, the display surface S102 of the display 103 would be located on the inner side in the casing 104 than the panel surface S101, leading to a lowering in visibility. In view of this, in the control panel device 101, a display substrate 111 supported by struts 110 is provided on the main substrate 106, and the display 103 is disposed on the display substrate 111, whereby the display surface S102 is disposed close to the panel surface S101, thereby enhancing the visibility.

Incidentally, there has been known a technology by which the light of a light emitting element or elements provided on a main substrate disposed inside a control panel device is led to a panel surface, with a keytop as a light guide member (refer to, for example, Japanese Patent Laid-open No. 2005-85506).

### SUMMARY OF THE INVENTION

In the control panel device 101 shown in FIGS. 1A and 1B, the display substrate 111 is provided separately from the main substrate 106, and the main substrate 106 and the display substrate 111 are connected to each other through a harness, connector or the like (not shown), and, therefore, the cost of the control panel device 101 is increased due to the costs of the parts such as the display substrate, the harness, the connector, etc. In addition, laying the harness around and the like lead to complication of the configuration of the inside of the control panel device 101 and difficulty in assembly, thereby increasing the burden of work.

Thus, there is a need for a control panel device and a display by which information can be displayed at an appropriate position spaced from one substrate, without providing any other substrate for the display.

According to an embodiment of the present invention, there is provided a control panel device includes: a substrate; a panel section disposed oppositely to one principal surface of the substrate, with a predetermined spacing therebetween; an operating member exposed at a panel surface, on the opposite side of the substrate, of the panel section; a detecting element provided on the substrate and operative to detect an operation on the operating member; a display for displaying information on the panel surface; and a control unit for controlling operations of the display based on a signal obtained according to detection by the detecting element; wherein the display includes: a light emitting element which is provided on the one principal surface of the substrate and the ON/OFF state of which is controlled by the control unit; a shaping member provided with a through-hole having a predetermined shape for permitting light from the light emitting element to pass therethrough to the panel section side; a rod lens array having an array of a plurality of rod-formed lenses extending from the shaping member side toward the panel section side; and a rear screen which is exposed at the panel surface and on which light in the predetermined shape coming from the rod lens array is projected.

Preferably, the shaping member is supported on the substrate and holds the rod lens array.

Preferably, a plurality of the light emitting elements are disposed on the one principal surface of the substrate; a plurality of the through-holes in the shaping member are arranged correspondingly to the positions of the plurality of light emitting elements; and the control unit controls independently the ON/OFF states of the plurality of light emitting elements.

Preferably, the rear screen is disposed at a position comparable to that of the panel section, in the direction in which the substrate and the panel section are opposed to each other.

According to another embodiment of the present invention, there is provided a display includes: a plurality of light emitting elements provided on one principal surface of a substrate; a shaping member provided with a plurality of through-holes having predetermined shapes and permitting light from the plurality of light emitting elements to pass therethrough in the direction in which the one principal surface faces, the plurality of through-holes being arranged correspondingly to the positions of the plurality of light emitting elements; a rod lens array having an array of a plurality of rod-formed lenses extending from the shaping member side in the direction in which the one principal surface faces; a rear screen on which light in the predetermined shapes coming from the rod lens array is projected; and a display control unit for controlling independently the ON/OFF states of the plurality of light emitting elements.

In the display, preferably, the shaping member is supported on the substrate and holds the rod lens array.

In the display, preferably, a plurality of the light emitting elements are disposed on the one principal surface of the substrate; a plurality of the through-holes in the shaping member are arranged correspondingly to the positions of the plurality of light emitting elements; and the control unit controls independently the ON/OFF states of the plurality of light emitting elements.

In the display, preferably, the rear screen is disposed at a position comparable to that of the panel section, in the direction in which the substrate and the panel section are opposed to each other.

According to the present invention, information can be displayed at an appropriate position spaced from one substrate, without providing any other substrate for the display.

The above and other features and advantages of the present invention will become apparent from the following description when taken in conjunction with the accompanying figures which illustrate preferred embodiments of the present invention by way of example.

### BRIEF DESCRIPTION OF THE DRAWINGS

FIGS. 1A and 1B show a perspective view of a control panel device according to the related art;

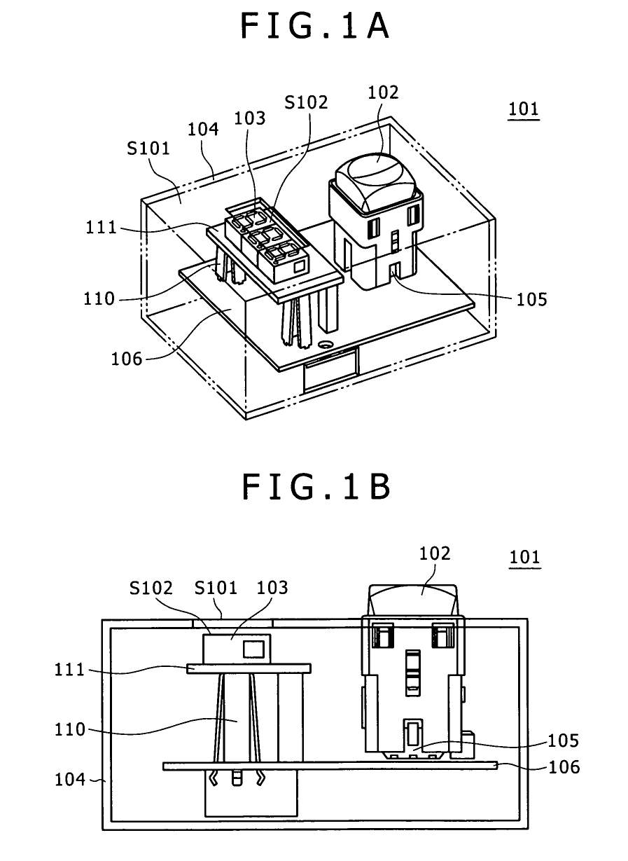

FIGS. 2A and 2B show a perspective view of a control panel device according to an embodiment of the present invention;

FIG. 3 shows an exploded perspective view of a display in the control panel device shown in FIGS. 2A and 2B;

FIGS. 4A and 4B show an appearance of a holder of the display shown in FIG. 3;

FIGS. 5A and 5B illustrate a rod lens array in the display shown in FIG. 3;

FIG. 6 is a sectional view schematically showing the layout of members of the display shown in FIG. 3; and

FIG. 7 is a block diagram showing the configuration of a signal processing system in the control panel device shown in FIGS. 2A and 2B.

### DETAILED DESCRIPTION OF THE PREFERRED EMBODIMENTS

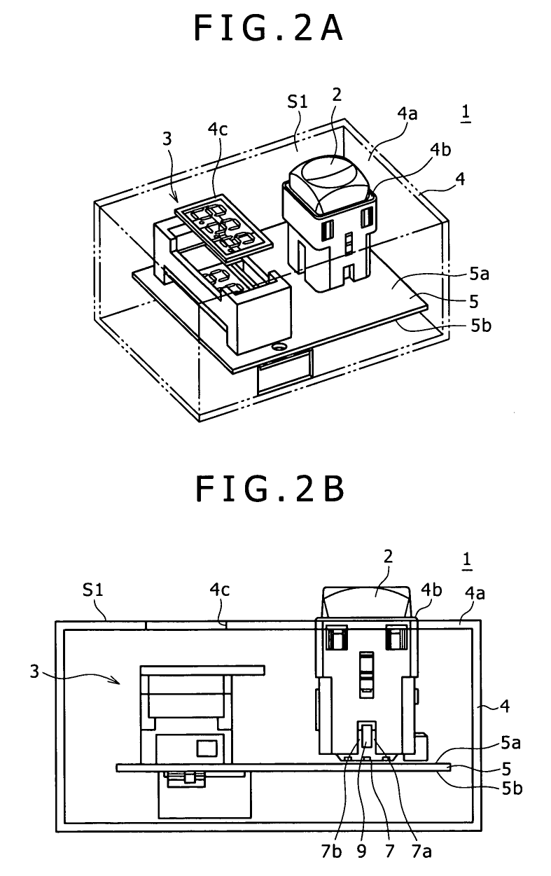

FIG. 2A is a perspective view which partly perspectively shows a control panel device 1 according to an embodiment of the present invention, and FIG. 2B is a side view which partly perspectively shows the control panel device 1. The control panel device 1 is for controlling the operation of a controlled system by depressing of a keytop 2, and information according to the depressing operation is displayed on a display 3. Incidentally, the keytop 2 is an example of the operating member.

The control panel device 1 has a casing 4, and a substrate 5 is provided in the inside of the casing 4. The casing 4 is formed, for example, of a resin or a metal. The casing 4 is, for example, a regular parallelepiped in shape, and has a flat plate-like panel section 4a constituting a surface on the upper side with respect to the figure. The panel section 4a is provided with an opening part 4b for exposing the keytop 2 at a panel surface S1 on the casing outer side (the opposite side of the substrate 5), and a window part 4c for exposing the display 3.

The substrate 5 is composed, for example, of a printed wiring board using a hard resin to form a base thereof, and is disposed in parallel to the panel section 4a so that its first principal surface 5a faces the panel section 4a. A detecting element 7 for detecting an operation on the keytop 2 is provided on the first principal surface 5a. In addition to this, the substrate 5 is provided with various electronic parts (not shown) such as an IC constituting a control circuit, etc. on the first principal surface 5a and a second principal surface 5b on the back side of the first principal surface 5a.

The detecting element 7 is composed, for example, of a photo detector, and, as shown in FIG. 2B, includes a light emitting section 7a, and a light receiving section 7b for detecting the light emitted from the light emitting section 7a. When the keytop 2 is depressed, a light shielding part 9 fixed to the keytop 2 is inserted between the light emitting section 7a and the light receiving section 7b. On the other hand, when the depressing of the keytop 2 is stopped, the keytop 2 is pushed back toward the upper side with respect to the figure by an urging section (not shown), and the light shielding part 9 is retracted from the position between the light emitting section 7a and the light receiving section 7b. The light receiving section 7b outputs an ON signal or an OFF signal according to the presence or absence of the light coming from the light emitting section 7a.

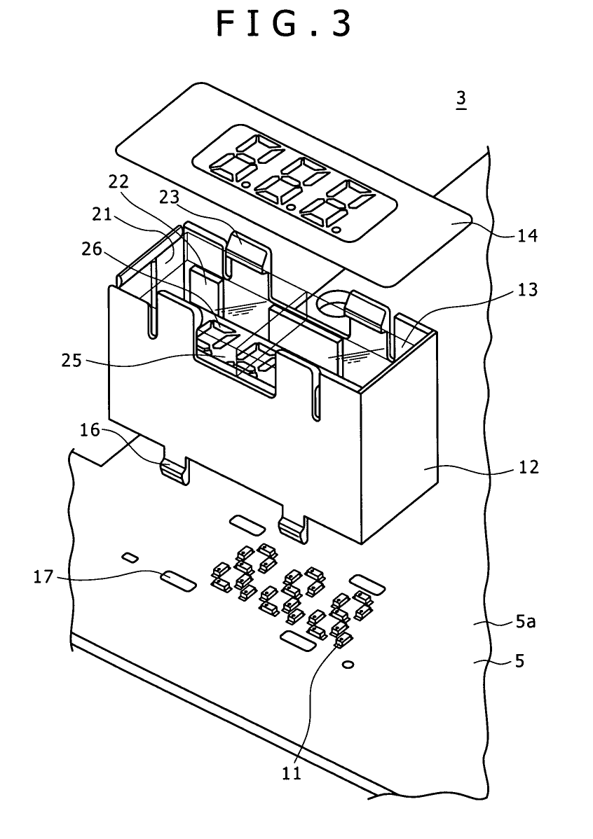

FIG. 3 is an exploded perspective view of the display 3. The display 3 is configured as a so-called 7-segment display and to be capable of displaying three digits. The display 3 includes LEDs (light emitting diodes) 11, a holder 12, a rod lens array 13, and a screen 14 in this order from the substrate 5 side toward the panel section 4a side. Incidentally, the LED 11 is an example of the light emitting element, and the holder 12 is an example of the shaping member.

The LEDS 11 are, for example, chip type LEDs, and are provided on the first principal surface 5a of the substrate 5. Specifically, the LED 11 has a cathode terminal and an anode terminal fixed respectively to conductor layers of the substrate 5, and is supplied with electric power through the conductor layers of the substrate 5. In addition, a plurality of the LEDs 11 are provided and arranged in a predetermined shape. To be more specific, seven LEDS 11 are provided correspondingly to seven segments for forming a numeral “8” at each digit, and one LED 11 is provided correspondingly to dots for separating the digits (numerals); thus, a total of 24 LEDs 11 are provided for the three digits.

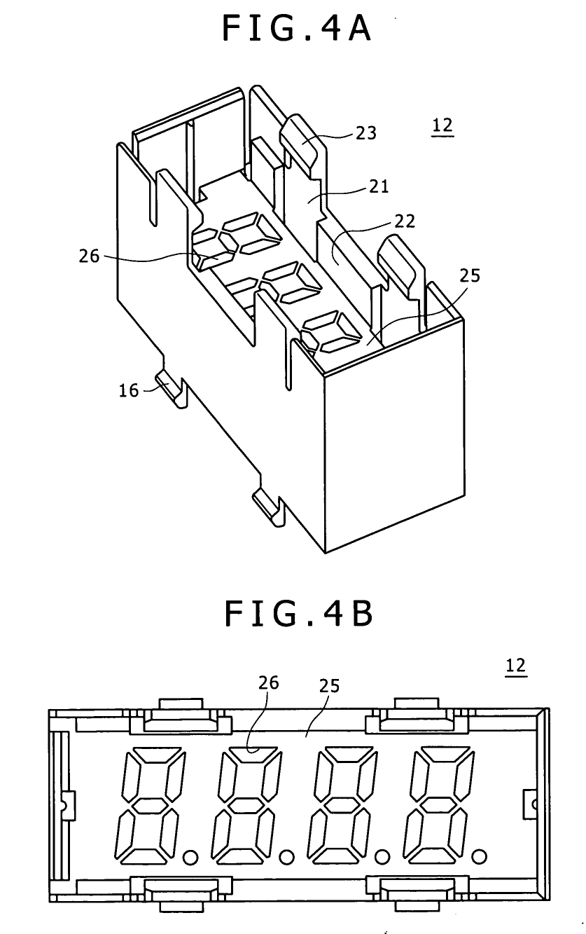

FIG. 4A is a perspective view of the holder 12, and FIG. 4B is a plan view of the holder 12, as viewed from the upper side with respect to the figure of FIG. 4A.

The holder 12 is formed, for example, of a resin or a metal. The holder 12 may be formed by coating a resin with a light-shielding coating material or by plating a resin with a metal, or may be formed of a metal, whereby the holder 12 is provided with a light-shielding property. The holder 12 is, for example, roughly a rectangular parallelepiped in general shape.

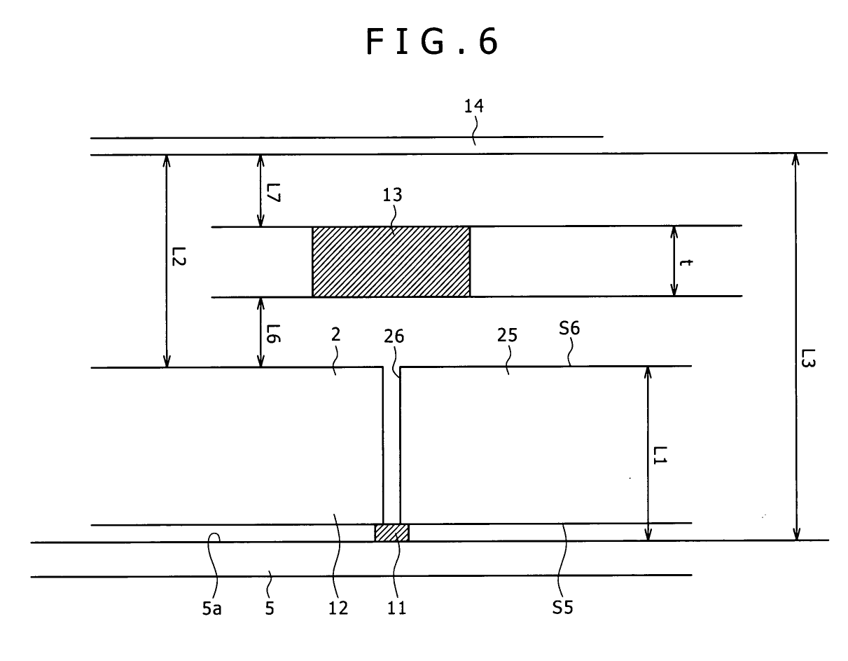

As shown in FIG. 3, the holder 12 is mounted on the first principal surface 5a of the substrate 5, and is fixed to the substrate 5 by a structure in which a plurality of pawl parts 16 projecting from the bottom surface of the holder 12 are inserted into a plurality of hole parts 17 provided in the substrate 5 and are engaged with the substrate 5. Incidentally, the bottom surface (the surface on the substrate 5 side) of the holder 12 is provided with a recessed part (not shown) having such an area as to cover the layout region of the LEDS 11 and a depth comparable to the height of the LEDS 11, and the bottom surface S5 (see FIG. 6), of the recessed part makes contact with the LEDS 11 or faces the LEDS 11, with a minute gap therebetween.

The holder 12 is provided with a recessed part (holding section) 21 for holding the rod lens array 13, on the screen 14 side (the upper side with respect to the figure). The plan-view shape of the recessed part 21 is such a shape that the rod lens array 13 can be fitted therein, for example a rectangle, and the rod lens array 13 is fitted in the recessed part 21 and is positioned in the directions along the substrate 5 (the directions orthogonal to the optical axis).

The recessed part 21 is formed to have a depth larger than the thickness of the rod lens array 13, and projected parts 22 projected to the inner side of the recessed part 21 are formed at positions, corresponding to a depth larger than the thickness of the rod lens array 13, of side surfaces of the recessed part 21 (on the side of the bottom portion of the recessed part 21). In addition, pawl parts 23 projecting from the side surfaces of the recessed part 21 toward the inner side are formed on the edge portion side (the upper side with respect to the figure) of the recessed part 21. When the rod lens array 13 is inserted into the recessed part 21, as shown in FIGS. 2A and 2B, edge portions of an end face, on the substrate 5 side, of the rod lens array 13 are locked by the projected parts 22, whereas edge portions of an end face, on the screen 14 side, of the rod lens array 13 are locked by the pawl parts 23, whereby the rod lens array 13 is positioned in the direction orthogonal to the substrate 5 (in the optical axis direction).

The bottom portion side of the recessed part 21 of the holder 12 constitutes a shaping section 25 for shaping the light from the LEDS 11. The shaping section 25 is formed to be, for example, roughly a rectangular parallelepiped in shape. The shaping section 25 is provided with through-holes 26 which penetrate the shaping section 25 in the direction orthogonal to the substrate 5 and through which the light from the LEDS 11 can pass toward the panel section 4a side (in the direction in which the principal surface 5a of the substrate 5 faces, or toward the upper side with respect to the figure).

The through-holes 26 include through-holes arranged in the same number as that of the LEDS 11 and arranged correspondingly to the positions of the LEDs 11. As shown in FIG. 4B, a total of 32 through-holes 26 are provided for four 7-segment digits and four dots; of the four digits, the three digits on the right side in the figure correspond to the positions of the LEDs 11. Incidentally, the through-holes 26 for one digit on the left side in the figure are provided as spare for enabling the number of the LEDs 11 disposed on the substrate 5 to be increased by a number corresponding to one digit. This enhances the versatility of the holder 12.

The through-holes 26 penetrate the shaping section 25 while maintaining predetermined sectional shapes. However, the through-holes 26 may be so formed that their sectional sizes decrease or increase as they extend in the penetrating direction. The sectional shapes of the through-holes 26 are the shapes for characters, symbols or the like to be displayed finally, i.e., the shapes for the characters, symbols or the like to be displayed on the screen 14. For example, the through-holes 26 corresponding to the segments of the 7-segment are formed in the shape of a tetragon, a pentagon, a hexagon or the like, and the through-holes 26 corresponding to the dots are formed in a circular shape. Incidentally, the light emitting surfaces of the LEDs 11 and the through-holes 26 are comparable in the size of sectional shape, and the shapes of the light emitting surfaces of the LEDs 11 are rectangles close to the shapes of the through-holes 26 corresponding to the segments of the 7-segment.

If the surface of the holder 12 has a dark color, the light from the LEDs 11 would be absorbed by the surface, whereby the quantity of light going out of the through-holes 26 is lowered. On the other hand, if the surface of the holder 12 has a light color, the light from one through-hole 26 would be scattered to the upper side of other through-holes 26, with the result that the outgoing light may not accurately reflect the shape of the through-hole 26. Therefore, the color of the surface of the holder 12 is preferably regulated as needed; for example, the color is set to gray with an appropriate brightness.

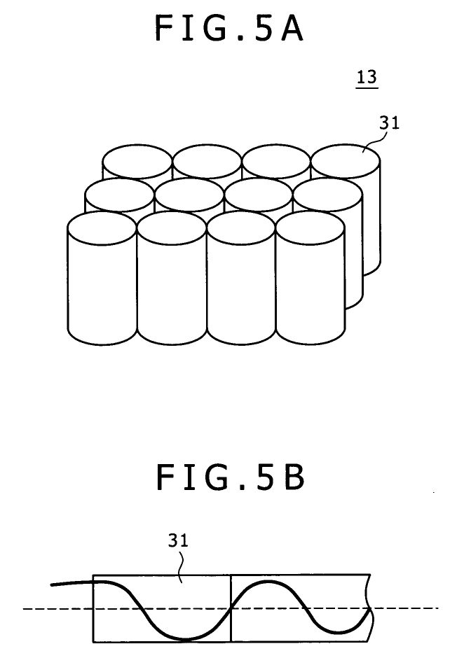

FIG. 5A is a perspective view schematically showing the rod lens array 13. The rod lens array 13 is so configured that an equal-size upright image of an incident light image is thereby projected. Incidentally, the rod lens array 13 may be so configured that an equal-size inverted image of the incident light image is thereby projected. The rod lens array 13 is formed by arraying in parallel a plurality of rod-formed rod lenses 31 extending from the holder 12 side toward the panel section 4a side (in the direction in which the first principal surface 5a of the substrate 5 faces, or toward the upper side with respect to the figure). Incidentally, the rod lenses 31 have an appropriate sectional shape such as a circle, and are so arrayed that the rod lens array 13 has an appropriate overall shape such as a thin-type rectangular parallelepiped.

FIG. 5B is a conceptual diagram illustrating the principle of the projection by the rod lens array 13. The light incident on an end face of the rod lens 31 is propagated in the rod lens 31 while meandering with a fixed period. Therefore, by setting the length of the rod lens 31 to an appropriate length, for example, ¾ times the meandering pitch of the incident light, an equal-size upright image of the incident light image can be projected by the rod lens array 13.

The screen 14 (FIG. 3) is configured as a so-called rear screen which displays on its front surface side a light image projected thereon from the rear surface side. The screen 14 is formed, for example, of an acrylic resin or glass in which a light diffusing substance is mixed. The screen 14 is so disposed as to close the window part 4c opened in the panel section 4a, and is located at a position comparable to that of the panel section 4a in the direction in which the substrate 5 and the panel section 4a are opposed to each other.

FIG. 6 is a diagram schematically showing the positional relationships among the substrate 5, the LED 11, the holder 12, the rod lens array 13 and the screen 14 (the panel section 4a), in the direction in which the substrate 5 and the panel section 4a are opposed to each other.

The LED 11 and the incidence surface S5 (the inlet of light of the through-hole 26) of the shaping section 25 of the holder 12 are in contact with each other or opposed to each other, with a minute gap therebetween, and the distance L1 from the first principal surface 5a of the substrate 5 to the light outgoing surface S6 (the outlet of light of the through-hole 26) of the shaping section 25 is comparable to the sum of the thickness of the LED 11 and the thickness of the shaping section 25.

The distance L2 from the outgoing surface S6 to the screen 14 is set to be comparable to the conjugate length (image-to-image distance) of the rod lens array 13. This ensures that the light outgoing from the outgoing surface S6 in the shape of the through-hole 26 is focused on the screen 14 as an equal-size upright image by the rod lens array 13.

Incidentally, a good visibility of the screen 14 is ensured when the screen 14 is so located that its height from the substrate 5 is comparable to that of the panel section 4a. Therefore, the distance L3 between the substrate 5 and the screen 14 is determined mainly by the distance between the substrate 5 and the panel section 4a. The distance between the substrate 5 and the panel section 4a is determined mainly by the sizes of the electronic parts and the like mounted on the substrate 5. Therefore, in general, the distance L3 is determined first, and then the settings of the conditions determining the distance L1 and the distance L2, for example, the setting of the thickness of the shaping section 25 in the holder 12 and the selection of the rod lens array 13 (the setting of the conjugate length) are conducted so that the sum of the distance L1 and the distance L2 will be equal to the distance L3.

An exemplar set of the performance of the LED 11, the sizes of the members, etc. are a size of the LED 11 of 1.6 (longitudinal)×0.8 (transverse)×0.6 (height) mm, a luminous intensity of the LED 11 of 28.6 to 62.8 mcd at a current of 20 mA, a wavelength of light from the LED 11 of 568 to 577 nm, a size of the rod lens array 13 of 32 (longitudinal)×12 (transverse)×3.9 (thickness t) mm, a conjugate length (distance L2) of the rod lens array 13 of 13.1 mm, a distance L1 of 9.7 mm, and a distance L3 of 22.8 mm. Incidentally, the rod lens array 13 is so laid out that the distance L6 from the outgoing surface S6 to the rod lens array 13 and the distance L7 from the rod lens array 13 to the screen 14 will be comparable to each other. It is to be noted here, however, there may be made an appropriate fine adjustment according to the performances of the rod lens array 13 and the like, for example, the setting of L6 to 4.9 mm and L7 to 4.3 mm.

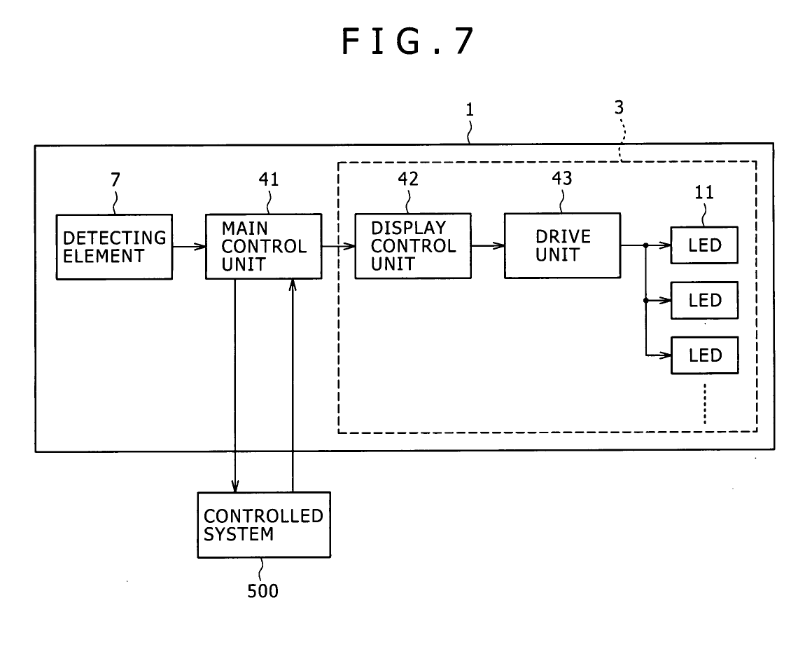

FIG. 7 is a block diagram showing the configuration of a signal processing system of the control panel device 1. The control panel device 1 includes a main control unit 41, a display control unit 42, and a drive unit 43. The main control unit 41, the display control unit 42, and the drive unit 43 are each configured to include an IC, for example, and are provided on the substrate 5. Incidentally, the main control unit is an example of the control unit in the control panel device according to an embodiment of the present invention.

The main control unit 41, upon receiving a detection signal from the detecting element 7, outputs to a controlled system 500 a control signal according to the detection signal. The controlled system 500 performs an action according to the control signal from the main control unit 41, and outputs to the main control unit 41 a signal indicating information obtained based on the action. For example, the controlled system 500 drives a motor on the basis of a speed command from the main control unit 41, detects by a sensor the speed of a moving section driven by the motor, and outputs the detection results to the main control unit 41.

In addition, the main control unit 41 outputs to the display control unit 42 a signal containing the information obtained according to the detection by the detecting element 7. The display control unit 42, in order to display the information contained in the signal from the main control unit 41, outputs a control signal to the drive unit 43, so as to independently control the ON/OFF states of the plurality of LEDs 11 through the drive unit 43. Based on the control signal from the display control unit 42, the drive unit 43 starts or stops the supply of electric power to the LEDs 11, thereby put the LEDS 11 into the ON or OFF state, respectively.

For example, speed data obtained from the controlled system 500 is outputted from the main control unit 41 to the display control unit 42, the display control unit 42 converts the speed data into information indicating those ones of the plurality of LEDs 11 which are to be turned ON, and outputs the information to the drive unit 43, which supplies electric power selectively to those ones of the plurality of LEDs 11 which, according to the instruction from the display control unit 42, are to be turned ON.

According to the embodiment described above, the display 3 includes: the LEDs 11 which are provided on the first principal surface 5a of the substrate 5 and the ON/OFF states of which are controlled by the main control unit 41; the holder 12 provided with the through-holes 26 of predetermined shapes for permitting the light from the LEDs 11 to pass therethrough to the panel section 4a side; the rod lens array 13 having an array of the plurality of rod lenses 13 extending from the holder 12 side toward the panel section 4a side; and the rear screen exposed at panel surface and onto which the light from the through-holes 26 is projected by the rod lens array 13. Therefore, information can be displayed at an appropriate position spaced from the substrate 5, without providing any other substrate for the display.

Specifically, the light from the LEDs 11 is shaped into a shape according to the information by the shapes of the through-holes, and the light thus shaped is guided by the rod lens array 13 over the length of the rod lens array 13 and projected on the screen 14. Therefore, by regulating the thickness of the shaping section 25 of the holder 12 (the length of the through-holes 26) or the like, an image in the shape according to the information can be displayed at an appropriate position spaced from by the distance L3 from the substrate 5. Moreover, since the light from the LEDs 11 is guided and projected by the through-holes 26, the rod lens array 13 and the screen 14, a lowering in luminous intensity is prevented from occurring.

Since the holder 12 is provided with the through-holes 26 and the holder 12 functions both as a holding member for holding the rod lens array 13 and as a shaping member provided with the through-holes 26, it is possible to contrive reductions in the number of component parts and the number of assembling steps.

Since the plurality of LEDs 11 are disposed on the first principal surface 5a of the substrate 5, the plurality of through-holes 26 are arranged correspondingly to the positions of the LEDS 11 and the ON/OFF states of the plurality of the LEDs 11 are controlled independently, a plurality of pieces of information can be displayed by a combination of the ON/OFF states of the plurality of LEDs 11.

Since the screen 14 is located at a position comparable to that of the panel section 4a in the direction in which the substrate 5 and the panel section 4a face each other, it is easy for the user to visually confirm the information displayed on the screen 14 while operating the control panel device 1.

The present invention is not limited to the above-described embodiment but may be carried out in a variety of modes.

The controlled system for the control panel device includes all controlled systems. Examples of the controlled system include industrial machines such as industrial robots, business machines such as copiers, and home electric apparatuses and appliances such as cameras. In addition, an arithmetic unit and the display provided in the control panel unit are also included in the controlled system.

The operating member is not limited to the push-type button, inasmuch as it is exposed at the panel surface. Examples of the operating member include a slide button and a lever. Moreover, an operating member fixed to the panel section may be adopted, for example, an operating member of an electrostatic-type switch which senses the contact therewith of a user's finger.

The operating element is not limited to a non-contact type sensor, inasmuch as it can detect an operation on the operating member. For example, a switch in which a circuit is made and broken according to contact between contacts may be used as the operating element.

The signal containing the information to be utilized in controlling the display by the control unit may be any signal that is obtained according to the detection by the detecting element. Examples of the signal include: the detection signal itself from the detecting element; a signal indicating the result of an arithmetic processing conducted by an arithmetic unit in the control panel device on the basis of the detection signal from the detecting element; and a signal which contain information relating to an action made by the controlled system on the basis of the detection signal and which is obtained from the controlled system or from other device than the controlled system.

The display is not limited to the 7-segment display, and the shapes of the through-holes may be selected appropriately. Examples of the display include a dot display type display in which dots to be turned ON are appropriately selected from among a multiplicity of dots arrayed evenly so as to freely display a character or characters such as Hiragana (Japanese alphabets) and Chinese characters, and a display for displaying a symbol such as an arrow or a figure modeled after something.

The combination of the arrangement of the plurality of light emitting elements with the arrangement of the plurality of through-holes may also be selected appropriately, and the number of the light emitting elements and the number of the through-holes may be different from each other. It suffices that the shapes and the number of the through-holes are appropriately selected according to the number of the segments constituting the character(s) or symbol(s) to be displayed, and that the positions and the number of the light emitting elements are set according to the combinations of the ON/OFF states required in relation to the plurality of through-holes.

While preferred embodiments of the present invention have been described using specific terms, such description is for illustrative purposes, and it is to be understood that changes and variations may be made without departing from the spirit or scope of the following claims.

What is claimed is:

1. A control panel device comprising:
a substrate;
a panel section disposed oppositely to one principal surface of said substrate, with a predetermined spacing therebetween;
an operating member exposed at a panel surface, on the opposite side of said substrate, of said panel section;
a detecting element provided on said substrate and operative to detect an operation on said operating member;
a display configured to display information on said panel surface; and
a control unit configured to control operations of said display based on a signal obtained according to detection by said detecting element;
wherein said display includes
a light emitting element which is provided on said one principal surface of said substrate and the ON/OFF state of which is controlled by said control unit;
a shaping member provided with a through-hole having a predetermined shape configured to permit light from said light emitting element to pass therethrough to the panel section side;
a rod lens array having an array of a plurality of rod-formed lenses extending from the shaping member side toward the panel section side; and
a rear screen which is exposed at said panel surface and on which light in said predetermined shape coming from said rod lens array is projected.

2. The control panel device according to claim 1, wherein
said shaping member is supported on said substrate and holds said rod lens array.

3. The control panel device according to claim 1, wherein
a plurality of said light emitting elements are disposed on said one principal surface of said substrate;
a plurality of said through-holes in said shaping member are arranged correspondingly to the positions of said plurality of light emitting elements; and
said control unit controls independently the ON/OFF states of said plurality of light emitting elements.

4. The control panel device according to claim 1, wherein
said rear screen is disposed at a position comparable to that of said panel section, in the direction in which said substrate and said panel section are opposed to each other.

5. A display comprising:
a plurality of light emitting elements provided on one principal surface of a substrate;
a shaping member provided with a plurality of through-holes having predetermined shapes and permitting light from said plurality of light emitting elements to pass therethrough in the direction in which said one principal surface faces, said plurality of through-holes being arranged correspondingly to the positions of said plurality of light emitting elements;
a rod lens array having an array of a plurality of rod-formed lenses extending from the shaping member side in the direction in which said one principal surface faces;
a rear screen on which light in said predetermined shapes coming from said rod lens array is projected; and
a display control unit configured to control independently the ON/OFF states of said plurality of light emitting elements.

6. The display according to claim 5, wherein
said shaping member is supported on said substrate and holds said rod lens array.

7. The display according to claim 5, wherein
a plurality of said light emitting elements are disposed on said one principal surface of said substrate;
a plurality of said through-holes in said shaping member are arranged correspondingly to the positions of said plurality of light emitting elements; and
said control unit controls independently the ON/OFF states of said plurality of light emitting elements.

8. The display according to claim 5, wherein
said rear screen is disposed at a position comparable to that of said panel section, in the direction in which said substrate and said panel section are opposed to each other.
